(19) United States
(12) Patent Application Publication
(10) Pub. No.: US 2024/0379986 A1
(43) Pub. Date: Nov. 14, 2024

(54) FLOW STRAIGHTENER FOR A FUEL CELL CATHODE SUBSYSTEM

(71) Applicant: GM GLOBAL TECHNOLOGY OPERATIONS LLC, Detroit, MI (US)

(72) Inventors: Orgil Erica, Auburn Hills, MI (US); Hussein Awkal, Macomb, MI (US); Raffaello Ardanese, Bloomfield Hills, MI (US); James J. Deininger, Wyandotte, MI (US); Alexander W. Marks, Sterling Heights, MI (US)

(73) Assignee: GM GLOBAL TECHNOLOGY OPERATIONS LLC, Detroit, MI (US)

(21) Appl. No.: 18/315,084

(22) Filed: May 10, 2023

(51) Int. Cl. H01M 8/2484; H01M 8/04089; H01M 8/04111; H01M 8/0438

(52) U.S. Cl. CPC H01M 8/2484; H01M 8/04089; H01M 8/04111; H01M 8/04395

(57) ABSTRACT

A system including a flow straightener for a fuel cell cathode subsystem is provided. The system includes an intake manifold including a tube configured for providing an airflow to a compressor of the fuel cell cathode subsystem. The intake manifold includes an inlet configured for receiving the airflow into the intake manifold. The system further includes a mass air flow sensor disposed upon the intake manifold and a flow straightener disposed within the intake manifold between the inlet and the mass air flow sensor. The intake manifold includes an upstream portion between the flow straightener and the intake manifold inlet. The intake manifold further includes a downstream portion between the flow straightener and the mass air flow sensor. The flow straightener is configured for causing the airflow within the downstream portion to be less turbulent than the airflow within the upstream portion.

### BACKGROUND

The disclosure generally relates to a system including an adjustable and modular flow straightener for a fuel cell cathode subsystem.

A fuel cell system may utilize a flow of hydrogen gas and an airflow including oxygen to generate electrical energy. Hydrogen gas may be stored in a pressurized tank, and the hydrogen gas may be delivered at a first desired pressure which may be above atmospheric pressure. Air may be compressed by a compressor to provide an airflow at a second desired pressure which may be above atmospheric pressure.

### SUMMARY

A system including a flow straightener for a fuel cell cathode subsystem is provided. The system includes an intake manifold including a tube configured for providing an airflow to a compressor of the fuel cell cathode subsystem. The intake manifold includes an intake manifold inlet configured for receiving the airflow into the intake manifold. The system further includes a mass air flow sensor module disposed upon the intake manifold and a flow straightener disposed within the intake manifold between the intake manifold inlet and the mass air flow sensor. The intake manifold includes an upstream portion upstream of the flow straightener between the flow straightener and the intake manifold inlet. The intake manifold further includes a downstream portion downstream of the flow straightener between the flow straightener and the mass air flow sensor. The flow straightener is configured for causing the airflow within the downstream portion to be less turbulent than the airflow within the upstream portion.

In some embodiments, the flow straightener includes a flow straightening lattice configured for segmenting the airflow into a plurality of smaller airflows and thereby reduce turbulence in the airflow and a collar surrounding the flow straightening lattice.

In some embodiments, the flow straightening lattice includes a recurring pattern of shapes.

In some embodiments, the recurring pattern of shapes includes a recurring pattern of hexagonal shapes.

In some embodiments, the hexagonal shapes include a width measured from a first flat wall to a second flat wall opposite the first flat wall in a range from 5 millimeters to 10 millimeters.

In some embodiments, the collar includes a depth measured from a first circular face of the collar to a second circular face of the collar in a range from 13 millimeters to 35 millimeters.

In some embodiments, the flow straightener is manufactured through an extrusion process, an injection molding process, or a three-dimensional printing process.

In some embodiments, the flow straightener is configured to provide an airflow downstream of the flow straightener with a surface uniformity in a range from 91% to 96%.

In some embodiments, the flow straightener is configured to be rotated relative to the intake manifold in order to control the airflow downstream of the flow straightener.

In some embodiments, the flow straightener or the intake manifold is indexed to provide a user with an angle of rotation of the flow straightener relative to the intake manifold.

In some embodiments, the flow straightener is configured to lock into a rotational orientation relative to the intake manifold.

In some embodiments, the flow straightener is a first flow straightener. The system further includes an annular spacer including a collar and a second flow straightener. The spacer is disposed between the first flow straightener and the second flow straightener.

In some embodiments, the flow straightener is a first flow straightener. The system further includes a second flow straightener and a third flow straightener. The first flow straightener, the second flow straightener; and the third flow straightener are arranged in series within the intake manifold.

In some embodiments, the intake manifold at a location of the flow straightener includes a first inner diameter. A portion of the intake manifold downstream of the flow straightener is tapered to gradually decrease to a second inner diameter that is relatively smaller than the first inner diameter.

According to one alternative embodiment, a system including a flow straightener for a fuel cell cathode subsystem is provided. The system includes an intake manifold including a tube configured for providing an airflow to a compressor of the fuel cell cathode subsystem. The intake manifold includes an intake manifold inlet configured for receiving the airflow into the intake manifold. The system further includes a mass air flow sensor module disposed upon the intake manifold and a first flow straightener disposed within the intake manifold between the intake manifold inlet and the mass air flow sensor. The first flow straightener includes a first collar including a first depth, measured from a first circular face of the first collar to a second circular face of the first collar, and a first flow straightening lattice of a first configuration. The system further includes a second flow straightener configured for replacing or augmenting the first flow straightener. The second flow straightener includes a second collar including a second depth, measured from a third circular face of the second collar to a fourth circular face of the second collar, and a second flow straightening lattice of a second configuration. The intake manifold includes an upstream portion upstream of the first flow straightener between the first flow straightener and the intake manifold inlet. The intake manifold further includes a downstream portion downstream of the first flow straightener between the first flow straightener and the mass air flow sensor. The first flow straightener is configured for causing the airflow within the downstream portion to be less turbulent than the airflow within the upstream portion.

In some embodiments, the first flow straightening lattice includes a recurring pattern of hexagonal shapes.

In some embodiments, the first flow straightener is configured to be rotated relative to the intake manifold in order to control the airflow downstream of the first flow straightener.

In some embodiments, the first flow straightener or the intake manifold is indexed to provide a user with an angle of rotation of the first flow straightener relative to the intake manifold.

In some embodiments, the first flow straightener is configured to lock into a rotational orientation relative to the intake manifold.

According to one alternative embodiment, a system including a flow straightener for a fuel cell cathode subsystem is provided. The system includes an intake manifold including a tube configured for providing an airflow to a compressor of the fuel cell cathode subsystem. The intake manifold includes an intake manifold inlet configured for receiving the airflow into the intake manifold. The system further includes a mass air flow sensor disposed upon the intake manifold and a flow straightener disposed within the intake manifold between the intake manifold inlet and the mass air flow sensor. The intake manifold includes an upstream portion upstream of the flow straightener between the flow straightener and the intake manifold inlet. The intake manifold further includes a downstream portion downstream of the flow straightener between the flow straightener and the mass air flow sensor. The flow straightener is configured for causing the airflow within the downstream portion to be less turbulent than the airflow within the upstream portion. The flow straightener is configured to be rotated relative to the intake manifold in order to control the airflow downstream of the flow straightener. The flow straightener or the intake manifold is indexed to provide a user with an angle of rotation of the flow straightener relative to the intake manifold. The flow straightener includes a raised feature configured to lock the flow straightener into a rotational orientation relative to the intake manifold.

The above features and advantages and other features and advantages of the present disclosure are readily apparent from the following detailed description of the best modes for carrying out the disclosure when taken in connection with the accompanying drawings.

### BRIEF DESCRIPTION OF DRAWINGS

FIG. 1 schematically illustrates in perspective view a fuel cell system (FCS) including an intake manifold, in accordance with the present disclosure;

FIG. 2 schematically illustrates in perspective view a portion of the intake manifold of FIG. 1, in accordance with the present disclosure;

FIG. 3 schematically illustrates a portion of the intake manifold in cross sectional view, in accordance with the present disclosure;

FIGS. 4A-4F schematically illustrate in perspective view six alternative embodiments of the flow straightener of FIG. 1, in accordance with the present disclosure;

FIG. 5 schematically illustrates in perspective view a configuration including an air intake manifold including a flow straightener encased there within, in accordance with the present disclosure;

FIG. 6 schematically illustrates in perspective view the configuration of FIG. 5 including the intake manifold and the flow straightener, in accordance with the present disclosure;

FIG. 7 schematically illustrates in cross sectional view a configuration including an intake manifold, in accordance with the present disclosure;

FIG. 8 schematically illustrates in cross sectional view a configuration including an intake manifold, in accordance with the present disclosure; and

FIG. 9 schematically illustrates in perspective view an alternative configuration including an intake manifold, a mass air flow sensor module, and a flow straightener, wherein the intake manifold includes a tapered section, in accordance with the present disclosure.

### DETAILED DESCRIPTION

A fuel cell system (FCS) is an exemplary self-contained power plant, useful in a wide variety of applications. An FCS may be a feature available with common dimensions, weight, and other similar parameters. Similarly, the FCS may be optimized for size, weight, power output, etc., based upon anticipated applications in which it is to be used. In one exemplary embodiment, an air inlet or an intake manifold configured to convey a flow of ambient air into the FCS for use by the fuel cell as a supply of oxygen gas may provide an airflow into the FCS.

In order to deliver an airflow to the fuel cell at a pressure higher than atmospheric air, an air compressor or pump may be utilized to pressurize the air. A compressor is an air compressor or pump that receives a flow of inlet air and provides a flow of pressurized output air. The intake manifold may provide the airflow into the compressor, and the compressor may pressurize the airflow and provide the pressurized airflow to the cathode or cathodes of the fuel cell.

Control of the fuel cell is provided, for example, with a computerized controller modifying operation of the compressor according to a number of factors including a pressure of the air within the intake manifold. The pressure within the intake manifold may be measured by a mass air flow sensor.

A mass air flow sensor provides a quantification of the air flowing past a sensor or mass air flow sensor data, describing an air flow rate within the intake manifold. Accuracy of the mass air flow sensor data varies depending upon different factors. One of the factors that may affect accuracy of the mass air flow sensor data is turbulence of the airflow moving through the intake manifold. Turbulence may be caused or increased by the geometry of the intake manifold. Curved portions of the intake manifold may increase turbulence of the airflow within the intake manifold.

Package space within the FCS may be a controlling factor in design of the FCS. The path that the intake manifold must route the airflow may be significantly impacted by package space concerns and may include one or more sharp bends in the intake manifold. Similarly, locations at which the mass air flow sensor may be placed within the intake manifold may be limited based upon package space concerns. As a result, the mass air flow sensor may be located in the airflow downstream of a sharp bend in the intake manifold, which may cause increased turbulence and decreased accuracy of the mass air flow sensor.

A flow straightener for a fuel cell cathode subsystem is provided. By straightening an airflow within an intake manifold, errors in mass air flow sensor data due to turbulence may be reduced. The flow straightener may transform an upstream airflow that is in a turbulent flow regime into a downstream airflow that is in a laminar flow regime. In another embodiment, the flow straightener may transform an upstream airflow that has a relatively high degree of turbulence into a downstream airflow that has a relatively low degree of turbulence. A flow straightener may include a flow straightening lattice configured for removing turbulence from the airflow going through the flow straightening lattice. The flow straightener may further include a collar or boundary portion configured for affixing the flow straightener at a desired location within an intake manifold.

The disclosed flow straighteners include geometries and lattice structures that allow for the control and optimization of air flow to enable stable air flow sensor readings. The flow straighteners varying lattice structures and may have different path lengths for optimized air flow. Furthermore, these devices are modulated in the sense that they may be stacked and/or rotated to have greater control of air flow.

The disclosed system may also have a “bevel” design which allows a user to create precise and unique configurations based on the rotation of the flow straighteners. One may also add “blank” straighteners to increase the length between the lattice structures. These features help to stabilize the air flow before it reaches the mass air flow sensor.

The disclosed system includes an air flow product that utilizes excellent lattice-structures, lattice combinations, flow lengths, and porosity that leads to enhanced or optimized air flow which may be produced through one of a three-dimensional printing process, an extrusion process, or an injection molding process. The disclosed system further provides an ability to combine multiple lattice designs in different orientations to have precise control of air flow essentially giving one the ability to create combinations or configurations of lattice structures leading to high control of air flow. The disclosed system additionally allows one to have on-demand tuning of air flow by allowing the rotation of one or more of the lattice structures to dial-in in an optimized air flow if changes occur in the system.

In one embodiment, a flow straightener may be produced including unique lattice structures with surface roughness and porosity that is achieved by using three-dimensional printing process. The resulting surface roughness and porosity provides additional control over the resulting airflow downstream of the flow straightener.

The flow straightener product allows for a wide range of surface uniformity, describing a uniformity of flow rate across the intake manifold at a point, wherein the uniformity may be controlled by the type of lattice structure utilized. The uniformity index changes based on the type of lattice structure. The disclosed system may provide surface uniformity in a range of 91% to 96%. The uniformity of a scalar quantity may be computed on a surface as follows.

$$Uniformity Index of φ = 1 - \frac{{\sum }_{f} \vert {φ}_{f} - \overline{φ} \vert {A}_{f}}{2 \vert \overline{φ} \vert {\sum }_{f} {A}_{f}} \qquad [ 1 ]$$

wherein φ̅ is the surface average of φ, φ_{ƒ} is the face value of the selected scalar, and A_{ƒ} is the area of a face.

The flow straightener may be adjustable. The flow straightening lattice may not be symmetric about a center line of the lattice. Variance in the geometry of the flow straightening lattice may enable tuning or adjustment of conditions of the airflow downstream from the flow straightener. An angular orientation of the flow straightening lattice may be utilized to control a condition of an airflow downstream from the flow straightening lattice. In one embodiment, the flow straightener and the intake manifold into which the flow straightener is to be installed may have indices marked on the components enabling a specific orientation of the flow straightener to be manually selected. In another embodiment, the orientation or rotation of the flow straightening device may be controlled mechanically or automatically with a computerized control.

The flow straightener product allows for a wide range of air flows that may be controlled by the type of orientation or “locking position” of the lattice structure. In the example below, a 4 grams/second difference in flow rate between a 0° and 75° position may be achieved. This allows for on-demand tuning of air flow.

The flow straighteners may include a “key” that allow them to be “locked” in specific orientations enabling custom flow configurations, on-demand flow optimization, and the ability to perform precise calibration. A “bevel” portion of the system may have “male-male”, “female-female”, “female-male”, ends depending on application.

The flow straightener may be modular, meaning that alternative or additional pieces may be added or removed from the intake manifold to achieve desired operation of the system. For example, the system may be configured to install one of multiple alternative flow straighteners. For example, the flow straightener may be available in multiple depths, for example, including 13 millimeters deep and 35 millimeters deep, with the depth describing a dimension measured parallel to the direction of the airflow through the flow straightener. The width or diameter of the flow straightener may be defined by a width of the intake manifold into which the flow straightener is to be installed.

The flow straighteners may connect to or be “stacked” with hollow straighteners to increase the overall length of a specific straightener. Additionally, combinations of lattice structures may be connected to give unique flow outcomes or recipes based on (1) lattice type and (2) lattice orientation. Furthermore, angles may be created in which a lattice piece may be connected allowing for bending. Finally, a bend section may also have lattice structure throughout instead of being hollow.

It is desirable to segment the undivided airflow within the intake manifold upstream of the flow straightener into small sections of airflow. This segmentation orders the airflow and reduces the turbulence of the air. The flow straightening lattice of the flow straightener may be a repeating pattern of shapes. It may be desirable to include as many shapes of a same size as possible within the flow straightening lattice. It may be desirable to segment the airflow into the pattern of shapes with as few wall sections as possible to reduce a flow restriction of the flow straightening lattice. One advantageous shape to repeat upon the flow straightening lattice is a hexagon. The hexagon shapes may repeat and nest against each other to provide a repeating pattern of shapes into which to segment the airflow.

In a flow straightening lattice, the repeating shape pattern may include the repeating shape in a varying size. For example, one flow straightening lattice may include hexagons with an exemplary width, measured from a flat wall of the hexagon shape to an opposing flat wall of the hexagon shape, of 5 millimeters, 6.75 millimeters, or 10 millimeters.

A system may include a plurality of the flow straighteners with varying depth and varying repeating shape width. Users of the system may change out or use in combination the varying flow straighteners to achieve a desired result in light of ambient conditions, such as ambient pressure and temperature, and speed of the airflow moving through the intake manifold.

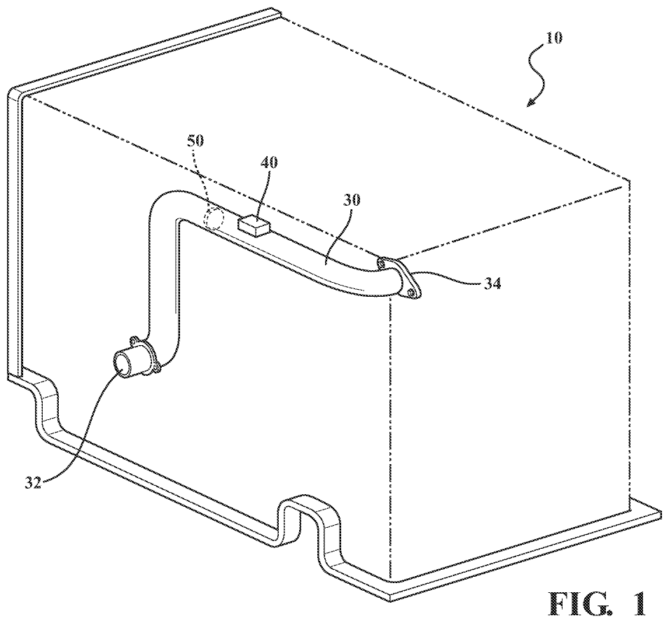

Referring now to the drawings, wherein like reference numbers refer to like features throughout the several views, FIG. 1 schematically illustrates in perspective view an FCS 10 including an intake manifold 30. The FCS 10 is illustrated as a dotted rectangular cube to illustrate an outer boundary of the FCS 10. Internal components aside from the intake manifold are not illustrated, but include at least one anode and cathode pair, a compressor configured to deliver a pressurized airflow to cathodes within the FCS 10, and a fuel gas delivery system providing a flow of fuel such as hydrogen gas to anodes within the FCS 10. The intake manifold 30 is illustrated including an intake manifold inlet 32 and an intake manifold outlet 34 configured for attachment to an inlet of a compressor. Computerized control of the FCS 10 benefits from accurate mass air flow readings from within the intake manifold 30. A mass air flow sensor module 40 is illustrated disposed upon the intake manifold 30. The mass air flow sensor module 40 provides a mass air flow sensor body within the airflow within the intake manifold and provides mass air flow sensor data for use in controlling the FCS 10.

The intake manifold 30 is not straight, but rather includes a series of sharp bends. The airflow within the intake manifold 30 must bend with the shape of the intake manifold 30. This changing of direction of the airflow within the intake manifold 30 may cause turbulence in the airflow which may interfere with collecting accurate mass air flow sensor data. A flow straightener 50 is illustrated disposed within the intake manifold. The intake manifold may be divided into sections to permit assembly of the flow straightener between the two sections. The disclosed FCS 10 may be utilized in a wide range of applications, including road vehicles such as electrically powered vehicles, construction vehicles or devices, power generation systems, airplanes, boats, infrastructure devices useful for buildings or other facilities, and other similar applications.

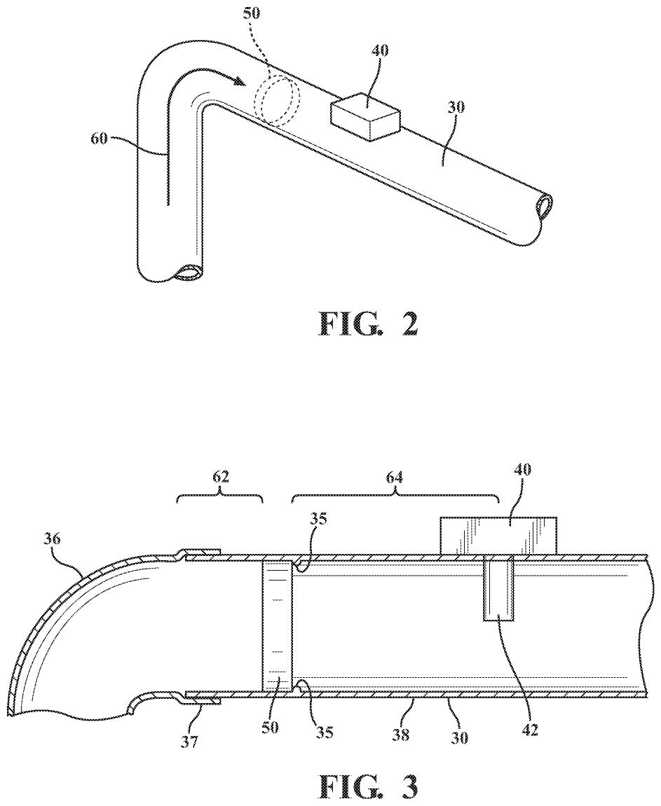

FIG. 2 schematically illustrates in perspective view a portion of the intake manifold 30 of FIG. 1. The mass air flow sensor module 40 is illustrated upon the intake manifold 30. The flow straightener 50 is illustrated disposed within the intake manifold 30. The flow straightener 50 may be a cylinder or coin-shaped device and may include a collar or boundary portion surrounding a flow straightening lattice spanning a center of the flow straightener 50. The collar may be visible from outside of the intake manifold. The collar may be entirely encased within the intake manifold. An arrow 60 illustrates a direction of airflow within the intake manifold 30.

FIG. 3 schematically illustrates a portion of the intake manifold 30 in cross sectional view. The flow straightener 50 is illustrated encased within the intake manifold 30. The intake manifold 30 is illustrated including a first section 36 and a second section 38. The mass air flow sensor module 40 including a mass air flow sensor body 42 is illustrated disposed upon the second section 38. The second section 38 includes exemplary raised beads 35 enabling the flow straightener 50 to seat against the raised beads 35. The raised beads 35 are exemplary, and a number of various details and wall profiles are envisioned which enable the flow straightener 50 to be placed and seated into a fixed position. Junction 37 is illustrated, where a portion of the first section 36 overlaps an outside surface of the second section 38 to join the sections 36, 38. Junction 37 may take many different forms, for example, including a crush ring configured to enable a constriction band, threaded fasteners, or other similar locking feature to affix the section 36, 38 to each other. The simplified illustration of junction 37 is intended to be a non-limiting example. An upstream portion 62 of the intake manifold 30 is illustrated upstream of the flow straightener 50. The airflow flows from this upstream portion 62 into the flow straightener 50. A downstream portion 64 of the intake manifold 30 is illustrated downstream of the flow straightener 50. The airflow flows from within the flow straightener into the downstream portion 64. The airflow within the upstream portion 62 may be turbulent. The flow straightener 50 segments the airflow into smaller airflows that pass through the flow straightener 50. The airflow passes through the flow straightener, where the turbulence in the air is reduced, and the airflow reforms into a single airflow in the downstream portion 64, where the airflow is less turbulent than it was in the upstream portion 62.

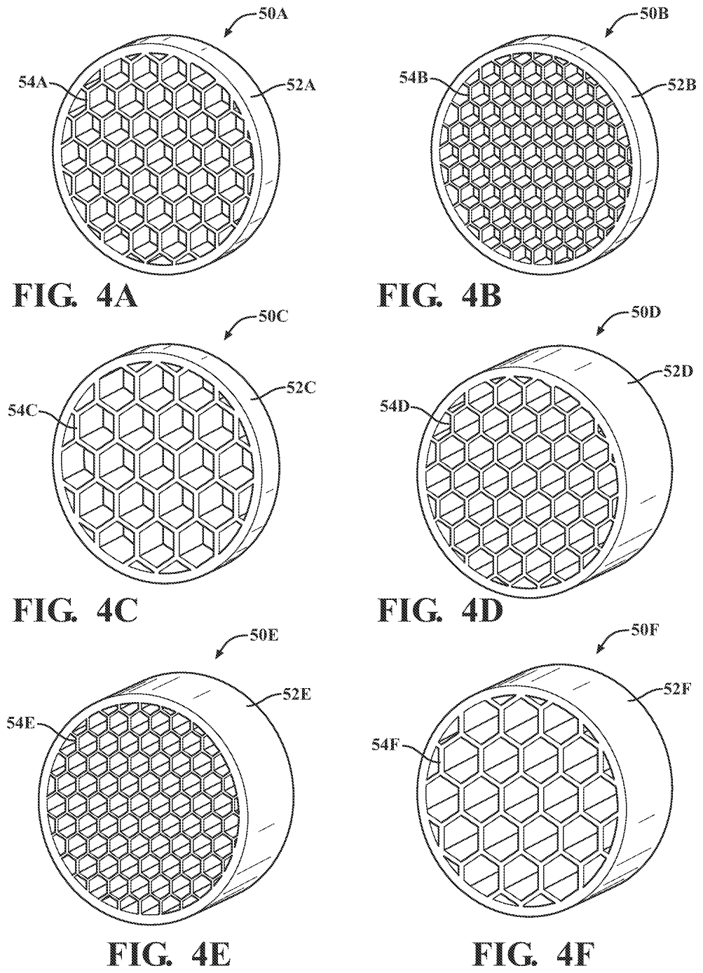

FIGS. 4A-4F schematically illustrate in perspective view six alternative embodiments of the flow straightener 50 of FIG. 1. Flow straightener 50A is illustrated including a collar 52A including an exemplary depth of 13 millimeters and flow straightening lattice 54A including a repeating hexagonal shape including a width from a first flat wall of the shape to a second flat wall of the shape of 6.75 millimeters. Flow straightener 50B is illustrated including a collar 52B including an exemplary depth of 13 millimeters and flow straightening lattice 54B including a repeating hexagonal shape including a width from a first flat wall of the shape to a second flat wall of the shape of 5 millimeters. Flow straightener 50C is illustrated including a collar 52C including an exemplary depth of 13 millimeters and flow straightening lattice 54C including a repeating hexagonal shape including a width from a first flat wall of the shape to a second flat wall of the shape of 10 millimeters. Flow straightener 50D is illustrated including a collar 52D including an exemplary depth of 35 millimeters and flow straightening lattice 54D including a repeating hexagonal shape including a width from a first flat wall of the shape to a second flat wall of the shape of 6.75 millimeters. Flow straightener 50E is illustrated including a collar 52E including an exemplary depth of 35 millimeters and flow straightening lattice 54E including a repeating hexagonal shape including a width from a first flat wall of the shape to a second flat wall of the shape of 5 millimeters. Flow straightener 50F is illustrated including a collar 52F including an exemplary depth of 35 millimeters and flow straightening lattice 54F including a repeating hexagonal shape including a width from a first flat wall of the shape to a second flat wall of the shape of 10 millimeters. An intake manifold may be configured to receive one or a plurality of the flow straighteners 50A, 50B, 50C, 50D, 50E, 50F at once. A spacer or a piece including a collar without a flow straightening lattice may be utilized to provide a defined space between two flow straighteners 50A, 50B, 50C, 50D, 50E, 50F.

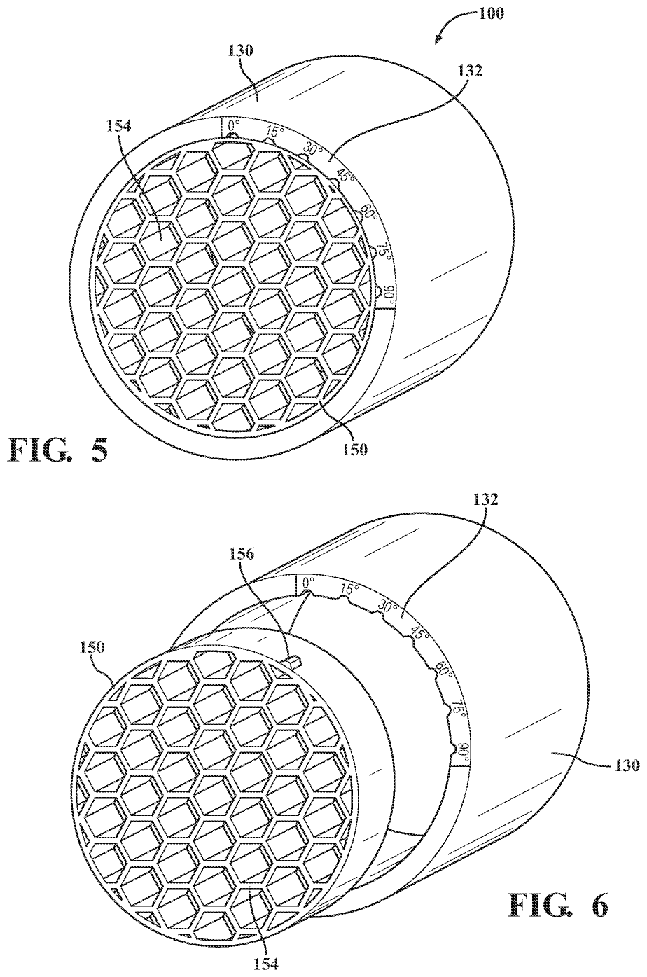

FIG. 5 schematically illustrates in perspective view a configuration 100 including an air intake manifold 130 including a flow straightener 150 encased there within. The air intake manifold 130 includes printed or embossed details 132 that index angles zero through ninety degrees to which a user may rotationally orient the flow straightener 150. By rotating the flow straightener 150, an orientation of the flow straightening lattice 154 may be controlled and thereby impact a condition of the airflow downstream of the air straightener 150.

FIG. 6 schematically illustrates in perspective view the configuration 100 of FIG. 5 including the intake manifold 130 and the flow straightener 150. The flow straightener 150 is removed from the intake manifold 130. A mark 156 is illustrated disposed upon a collar of the flow straightener 150 such that a user may align the mark 156 to the details 132 and thereby select a rotational orientation of the flow straightening lattice 154. In one embodiment, the mark 156 includes a raised feature and the intake manifold includes a plurality of indentations configured to receive the raised feature, such that the mark 156 may lock into place within an indentation in the intake manifold 130.

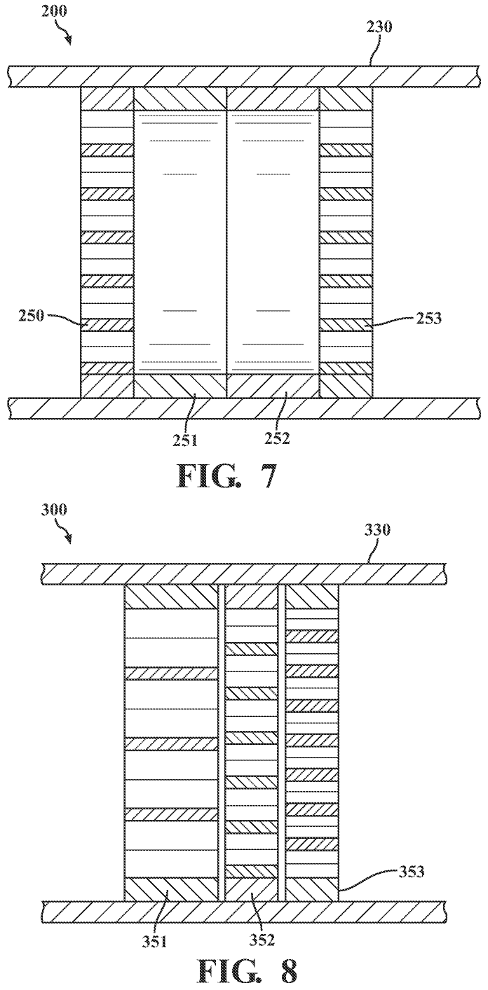

FIG. 7 schematically illustrates in cross sectional view a configuration 200 including an intake manifold 230. A first flow straightener 250, a first spacer 251, a second spacer 252, and a second flow straightener 253 are illustrated encased within the intake manifold 230. The first flow straightener 250, the first spacer 251, the second spacer 252, and the second flow straightener 253 are arranged in series within the intake manifold 230.

FIG. 8 schematically illustrates in cross sectional view a configuration 300 including an intake manifold 330. A first flow straightener 351, a second flow straightener 352, and a third flow straightener 353 are illustrated encased within the intake manifold 330. The flow straighteners 351, 352, 353 are illustrated including different depths and shape widths. The first flow straightener 351, the second flow straightener 352, and the third flow straightener 353 are arranged in series within the intake manifold 330.

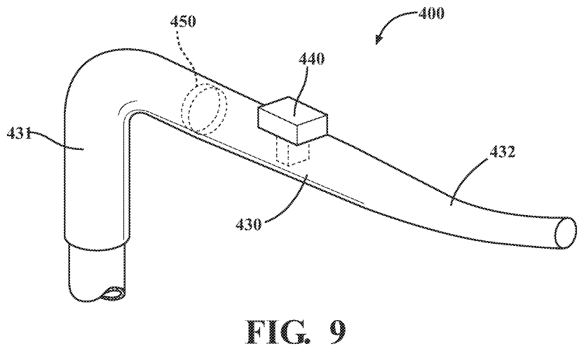

FIG. 9 schematically illustrates in perspective view an alternative configuration 400 including an intake manifold 430, a mass air flow sensor module 440, and a flow straightener 450. The intake manifold 430 includes a first section 431 including a substantially constant diameter tube. The intake manifold 430 further includes a second section 432 including a tapered portion wherein a diameter of the intake manifold 430 gradually decreases. The tapered portion may be incorporated to achieve desirable air flow and package space requirements.

While the best modes for carrying out the disclosure have been described in detail, those familiar with the art to which this disclosure relates will recognize various alternative designs and embodiments for practicing the disclosure within the scope of the appended claims.

What is claimed is:

1. A system including a flow straightener for a fuel cell cathode subsystem, the system comprising:
an intake manifold including a tube configured for providing an airflow to a compressor of the fuel cell cathode subsystem, wherein the intake manifold includes an intake manifold inlet configured for receiving the airflow into the intake manifold;
a mass air flow sensor disposed upon the intake manifold; and
a flow straightener disposed within the intake manifold between the intake manifold inlet and the mass air flow sensor; and
wherein the intake manifold includes an upstream portion upstream of the flow straightener between the flow straightener and the intake manifold inlet;
wherein the intake manifold further includes a downstream portion downstream of the flow straightener between the flow straightener and the mass air flow sensor; and
wherein the flow straightener is configured for causing the airflow within the downstream portion to be less turbulent than the airflow within the upstream portion.

2. The system of claim 1, wherein the flow straightener includes:
a flow straightening lattice configured for segmenting the airflow into a plurality of smaller airflows and thereby reduce turbulence in the airflow; and
a collar surrounding the flow straightening lattice.

3. The system of claim 2, wherein the flow straightening lattice includes a recurring pattern of shapes.

4. The system of claim 3, wherein the recurring pattern of shapes includes a recurring pattern of hexagonal shapes.

5. The system of claim 4, wherein the hexagonal shapes include a width measured from a first flat wall to a second flat wall opposite the first flat wall in a range from 5 millimeters to 10 millimeters.

6. The system of claim 2, wherein the collar includes a depth measured from a first circular face of the collar to a second circular face of the collar in a range from 13 millimeters to 35 millimeters.

7. The system of claim 1, wherein the flow straightener is manufactured through an extrusion process, an injection molding process, or a three-dimensional printing process.

8. The system of claim 1, wherein the flow straightener is configured to provide an airflow downstream of the flow straightener with a surface uniformity in a range from 91% to 96%.

9. The system of claim 1, wherein the flow straightener is configured to be rotated relative to the intake manifold in order to control the airflow downstream of the flow straightener.

10. The system of claim 9, wherein the flow straightener or the intake manifold is indexed to provide a user with an angle of rotation of the flow straightener relative to the intake manifold.

11. The system of claim 9, wherein the flow straightener is configured to lock into a rotational orientation relative to the intake manifold.

12. The system of claim 1, wherein the flow straightener is a first flow straightener; and
further comprising:
an annular spacer including a collar; and
a second flow straightener; and
wherein the annular spacer is disposed between the first flow straightener and the second flow straightener.

13. The system of claim 1, wherein the flow straightener is a first flow straightener; and
further comprising:
a second flow straightener; and
a third flow straightener; and
wherein the first flow straightener, the second flow straightener; and the third flow straightener are arranged in series within the intake manifold.

14. The system of claim 1, wherein the intake manifold at a location of the flow straightener includes a first inner diameter; and
wherein a portion of the intake manifold downstream of the flow straightener is tapered to gradually decrease to a second inner diameter that is relatively smaller than the first inner diameter.

15. A system including a flow straightener for a fuel cell cathode subsystem, the system comprising:
an intake manifold including a tube configured for providing an airflow to a compressor of the fuel cell cathode subsystem, wherein the intake manifold includes an intake manifold inlet configured for receiving the airflow into the intake manifold;
a mass air flow sensor disposed upon the intake manifold;
a first flow straightener disposed within the intake manifold between the intake manifold inlet and the mass air flow sensor, wherein the first flow straightener includes:
a first collar including a first depth, measured from a first circular face of the first collar to a second circular face of the first collar; and
a first flow straightening lattice of a first configuration; and
a second flow straightener configured for replacing or augmenting the first flow straightener, wherein the second flow straightener includes:
a second collar including a second depth, measured from a third circular face of the second collar to a fourth circular face of the second collar; and
a second flow straightening lattice of a second configuration; and
wherein the intake manifold includes an upstream portion upstream of the first flow straightener between the first flow straightener and the intake manifold inlet;
wherein the intake manifold further includes a downstream portion downstream of the first flow straightener between the first flow straightener and the mass air flow sensor; and
wherein the first flow straightener is configured for causing the airflow within the downstream portion to be less turbulent than the airflow within the upstream portion.

16. The system of claim 15, wherein the first flow straightening lattice includes a recurring pattern of hexagonal shapes.

17. The system of claim 15, wherein the first flow straightener is configured to be rotated relative to the intake manifold in order to control the airflow downstream of the first flow straightener.

18. The system of claim 17, wherein the first flow straightener or the intake manifold is indexed to provide a user with an angle of rotation of the first flow straightener relative to the intake manifold.

19. The system of claim 17, wherein the first flow straightener is configured to lock into a rotational orientation relative to the intake manifold.

20. A system including a flow straightener for a fuel cell cathode subsystem, the system comprising:
an intake manifold including a tube configured for providing an airflow to a compressor of the fuel cell cathode subsystem, wherein the intake manifold includes an intake manifold inlet configured for receiving the airflow into the intake manifold;
a mass air flow sensor disposed upon the intake manifold; and
a flow straightener disposed within the intake manifold between the intake manifold inlet and the mass air flow sensor; and
wherein the intake manifold includes an upstream portion upstream of the flow straightener between the flow straightener and the intake manifold inlet;
wherein the intake manifold further includes a downstream portion downstream of the flow straightener between the flow straightener and the mass air flow sensor;
wherein the flow straightener is configured for causing the airflow within the downstream portion to be less turbulent than the airflow within the upstream portion;
wherein the flow straightener is configured to be rotated relative to the intake manifold in order to control the airflow downstream of the flow straightener;
wherein the flow straightener or the intake manifold is indexed to provide a user with an angle of rotation of the flow straightener relative to the intake manifold; and
wherein the flow straightener includes a raised feature configured to lock the flow straightener into a rotational orientation relative to the intake manifold.
